(19) United States
(12) Patent Application Publication
(10) Pub. No.: US 2008/0113693 A1
(43) Pub. Date: May 15, 2008

(54) APPARATUS AND METHOD FOR CONTROLLING ELECTRIC POWER OF BATTERY ACCORDING TO RECEIVED SIGNAL STRENGTH INDICATOR OF DUAL BAND DUAL MODE TERMINAL

(75) Inventor: Jee Yong Yoo, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., LTD, Suwon-si (KR)

(21) Appl. No.: 11/877,179

(22) Filed: Oct. 23, 2007

(30) Foreign Application Priority Data
Nov. 9, 2006 (KR) 2006-0110684

(51) Int. Cl. H04M 1/02

(52) U.S. Cl. 455/574

(57) ABSTRACT

An apparatus and method for battery power management are disclosed utilizing Received Signal Strength Indicator (RSSI) of a dual band dual mode terminal, that includes a mobile communication unit; a portable Internet unit for transmitting/receiving a portable Internet signal; a battery measuring unit for measuring remaining battery capacity; a power supply unit for supplying power from the battery to the mobile communication unit and portable Internet unit; and a controller for deriving remaining run times of the mobile communication and portable internet units using consumption current according to the RSSI of the mobile communication and portable Internet units when the remaining battery capacity falls below a set value, and for controlling power supply of the power supply unit based on the derived remaining run times.

### PRIORITY

This application claims priority under 35 U.S.C. § 119(a) to an application entitled “APPARATUS AND METHOD FOR CONTROLLING ELECTRIC POWER OF BATTERY ACCORDING TO RECEIVED SIGNAL STRENGTH INDICATOR OF DUAL BAND DUAL MODE TERMINAL” filed in the Korean Intellectual Property Office on Nov. 9, 2006 and assigned Serial No. 2006-0110684, the contents of which are incorporated herein by reference.

### BACKGROUND OF THE INVENTION

1. Field of the Invention

The present invention relates to a Dual Band Dual Mode (DBDM) terminal, and more particularly to a method for reducing electric power consumption of a battery of a DMB terminal by restricting functions of the DBDM terminal according to Received Signal Strength Indicator (RSSI) levels.

2. Description of the Related Art

In general, portable terminals are powered by a battery having an electric power capacity, and thus can be continuously operated until the battery runs out of the limited electric power capacity. For example, a DBDM terminal, which simultaneously provides a mobile communication telephone service and portable Internet service, must supply electric power to its various components that function to provide the services. However, when the DBDM terminal simultaneously provides both telephone and Internet services, it consumes a relatively high amount of electric power. Specifically, when the DBDM terminal is used in a location where the RSSI level indicates a weak electric field, power consumption increases. As such, when the DBDM terminal supplies electric power from the battery to all components for providing all services even in a place requiring a large power consumption, the terminal cannot provide all services using only the remaining electric power capacity of the battery.

### SUMMARY OF THE INVENTION

In order to solve the above problems, the present invention is to provide an apparatus and method for controlling electric power from the battery of a portable terminal, which can select one of a plurality of functions when its remaining battery capacity cannot serve the functions and provide the service corresponding to the selected function, thereby extending the remaining run time of the DBDM terminal.

In accordance with an aspect of the present invention, there is provided an apparatus of electric power management according to the Received Signal Strength Indicator (RSSI) level of a Dual Band Dual Mode (DBDM) terminal that provides a mobile communication service and a portable Internet service. The apparatus includes a mobile communication unit for transmitting/receiving a mobile communication signal according to a protocol defined in the standard for the mobile communication service; a portable Internet unit for transmitting/receiving a portable Internet signal based on a protocol defined by the standard for the portable Internet service; a battery measuring unit for measuring the remaining capacity of a battery; a power supply unit for supplying power from the battery to the mobile communication unit and portable Internet unit; and a controller for deriving the remaining run times of the mobile communication unit and portable internet unit using consumption current according to the RSSI of the mobile communication unit and the portable Internet unit when the battery remaining capacity of the battery measuring unit is less than a set value, and for controlling power supply of the power supply unit based on the derived remaining run times.

Preferably, the apparatus further includes a display for displaying the remaining run times derived by the controller.

Preferably, the apparatus still further includes a storage unit for storing characteristic information created from specification of the battery and information created from consumption current according to RSSI.

Preferably, the apparatus further includes an antenna for transmitting/receiving the mobile communication signal and the portable Internet signal to/from a base station.

In accordance with another aspect of the present invention, there is provided a method of electric power management according to RSSI level of a DBDM terminal that provides a mobile communication service and a portable Internet service, simultaneously. The method includes detecting occurrence of an event performing the mobile communication service and portable Internet service, simultaneously; measuring consumption current of the battery when the event occurred, and determining as to whether the consumption current is less than the a preset critical value; calculating remaining run times in the case that the respective services are individually provided, and remaining run time in the case that the services are simultaneously provided, based on the RSSI of the respective services, when the consumption current is less than the critical value; and restricting power supply according to the remaining run times, and providing at least one or more of the services.

Preferably, the restricting power supply according to the remaining run times, and providing at least one or more of the services, includes displaying the remaining run times; detecting input signals corresponding to the remaining run times; and restricting power supply according to the detected input signal, and providing at least one or more of the services.

Preferably, the provided service has a remaining run time longer than that of other service, wherein the provided service and other service are the mobile communication service and the portable Internet service.

Preferably, the restricting power supply according to the remaining run times, and providing at least one or more of the services, includes providing all the services when the battery is newly received by the portable terminal.

Preferably, the calculation includes measuring consumption currents for the respective services according to the RSSI; comparing the consumption currents with battery characteristic information previously stored; and based on the comparison, calculating remaining run times in the case that the respective services are individually provided, and remaining run time in the case that the services are simultaneously provided.

### BRIEF DESCRIPTION OF THE DRAWINGS

The above and other features, and advantages of the present invention will be more apparent from the following detailed description in conjunction with the accompanying drawings, in which:

FIG. 1 is a schematic block diagram illustrating a portable terminal according to an embodiment of the present invention;

FIG. 2 is a graph of battery storage characteristic information according to an embodiment of the present invention;

FIG. 3 is a flow chart describing a method for controlling current consumption of a portable terminal according to an embodiment of the present invention;

FIG. 4 shows a display corresponding to the method for controlling current consumption of a portable terminal according to an embodiment of the present invention; and

FIG. 5 is a flow chart describing a method for controlling electric-power from the battery of a portable terminal according to a preferred embodiment of the present invention.

### DETAILED DESCRIPTION OF THE PREFERRED EMBODIMENTS

Hereinafter, preferred embodiments of the present invention are described in detail with reference to the accompanying drawings. The following terms are defined considering functions of the portable terminal according to the present invention, and may be changed by users or operators according to their needs. Therefore, the terms will be defined throughout the contents of this description.

The portable terminal according to the present invention is a Dual Band Dual Mode (DBDM) terminal that can provide all of the mobile communication services and the portable Internet services. Preferably, the portable terminal includes a mobile communication terminal, digital broadcasting terminal, Personal Digital Assistant (PDA) terminal, smart phone, International Mobile Telecommunication 2000 (IMT-2000) terminal, Wideband Code Division Multiple Access (WCDMA) terminal, Universal Mobile Telecommunication Service (UMTS) terminal, and GSM terminal, etc. Also, it will be readily appreciated that the present invention can be applied to all information communication devices, multimedia devices, and applications thereof, which are manufactured as a function module for providing mobile communication service and portable Internet service is installed to the portable terminal. Hereinafter, the DBDM terminal is referred to as the portable terminal.

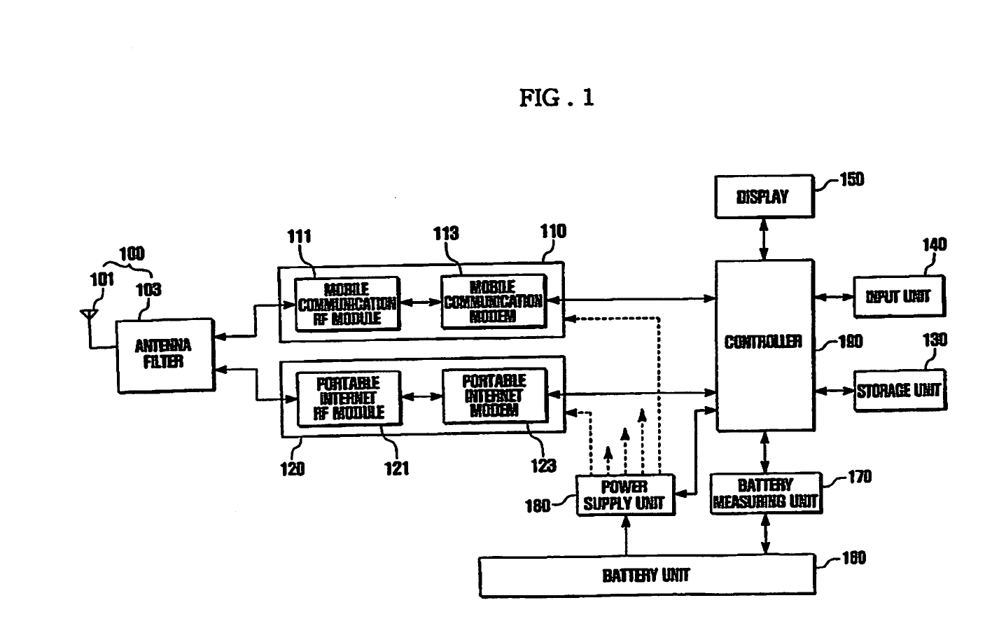

FIG. 1 is a schematic block diagram illustrating a portable terminal according to an embodiment of the present invention. As shown in FIG. 1, the portable terminal includes an antenna 100, a mobile communication unit 110, a portable Internet unit 120, a storage unit 130, an input unit 140, a display 150, a battery unit 160, a battery measuring unit 170, a power supply unit 180 and a controller 190.

The antenna 100 is configured to include an RF antenna 101 and an antenna filter 103. The RF antenna 101 receives an RF signal transmitted from a wireless base station and transmits the signal to the antenna filter 103. Also, the antenna 100 transmits an RF signal from the antenna filter 103 to another antenna. That is, the antenna 103 transmits/receives a mobile communication signal and/or portable Internet signal. The antenna filter 103 separates the RF signal from the RF antenna 101 into a mobile communication signal and portable Internet signal based on frequencies, and then transmits the signals to the mobile communication unit 110 and portable Internet unit 120, respectively. Here, the mobile communication service and the portable Internet service are provided through different frequency bands. For example, the frequency bands of CDMA and Wireless Broadband (WiBro) are 800 MHz and 2.3 GHz, respectively. Therefore, the antenna filter 103 is configured in such a way that a Band Pass Filter (BPF), High Pass Filter (HPF), and Low Pass Filter (LPF), etc. are combined to separate the frequency band signal. Also, the antenna filter 103 is configured to connect to a diplexer, so that the two signals divided by the diplexer can be used for the respective functions. Although the present invention is described based on an embodiment that employs one RF antenna 101, it will be appreciated that the present invention is not limited by the embodiment. For example, the mobile communication unit 110 and the portable Internet unit 120 can employ independent RF antennas.

The mobile communication unit 110 includes a mobile communication RF module 111 and a mobile communication modem 113. The mobile communication RF module 111 demodulates the mobile communication signal transmitted from the antenna filter 103 and transmits the signal to the mobile communication modem 113. Also, the mobile communication unit 110 modulates transmission data transmitted from the mobile communication modem 113, and transmits the modulated data to the RF antenna 101. The mobile communication modem 130 processes a mobile communication signal received from the mobile communication RF module 111, and performs a call process according to a protocol defined in the mobile communication standard.

The portable Internet unit 120 includes a portable Internet RF module 121 and a portable Internet modem 123. The portable Internet RF module 121 demodulates a portable Internet signal transmitted from the antenna filter 103 and transmits the signal to the portable Internet modem 123. Also, the portable Internet RF module 121 modulates transmission data from the portable Internet modem 123 and transmits the modulated data through the RF antenna 101. The portable Internet modem 123 processes a portable Internet signal received from the portable Internet RF module 121 and performs call processing according to a protocol defined in the portable Internet standard. When the portable terminal is operated in a mobile communication mode and a portable Internet mode, respectively, under the control of the controller 190, which will be described later, it is operated in such a way that modems 113 and 123, which process signals of corresponding modes, initialize the corresponding network; a corresponding mode is changed to an idle mode; authentication of a corresponding network is acquired to perform a location registration procedure; and a service of a corresponding mode is provided through outgoing/incoming call procedure. The portable terminal in the idle mode consumes approximately 50 mA of electric current. Here, the initialization refers to a process where information needed by the terminal is set and then an environment for transition toward the next idle mode is prepared. The initialization is performed in the following sequence: system determination substate, pilot channel acquisition substate, and sync channel acquisition substate, etc. Here, since the initialization of the portable terminal is well known to those skilled in the art, a detailed description will be omitted.

Specifically, the mobile communication modem 113 does not affect the setting of the portable Internet modem 123, and vice versa. That is, the mobile communication modem 113 and the portable Internet modem 123 are independently operated by the controller 190. For example, when the portable terminal operates in a mobile communication mode and the mobile communication modem 113 is in a traffic state, the portable Internet modem 123 may be operated to perform location registration and call setting to the portable Internet network.

The storage unit 130 is preferably configured to include a program area for storing an operating system that serves to process operations of a portable terminal, in real time, and software that serves to process the respective functions of the portable terminal; and a data area for storing program variables or information, which are created as the software operates. The storage unit 130 is connected to the controller 190, mobile communication modem 113, and portable Internet modem 123, etc., respectively, and stores data created from corresponding devices. Here, the storage unit 130 may be implemented with a flash memory, for example, a nonvolatile memory having a rapid data processing speed.

The input unit 140 has keys arranged in a matrix form, and creates a key value inputted by a user to provide it to the controller 190.

The display 150 is preferably implemented with Liquid Crystal Display (LCD), and provides various Graphic User Interfaces (GUI) to a user, under the control of the controller 190. Also, the display 150 preferably includes icons, and a lamp, and/or a vibrator, etc., notify of an incoming call.

The battery unit 160 as a power source is provided to the portable terminal, and is generally referred to as a battery pack. The battery measuring unit 170 is a controlling unit that can monitor the remaining capacity and state of a battery. The battery measuring unit 170 measures the battery state and then transmits this information to the controller. The battery measuring unit 170 measures battery voltage, charging/discharging currents between the battery and the portable terminal, remaining battery capacity, temperature of the battery pack, charging capacity when the battery is fully charged, and the battery design capacity, etc. The power supply unit 180 supplies power to respective elements included in the portable terminal according to control signals of the controller. In other words, the power of the power supply unit 180 may not be supplied to a specific element according to the control of the controller 190, as occasion demands.

The controller 190 controls the entire operation of the portable terminal. The controller 190 controls a corresponding modem by transmitting control signals to the mobile communication modem 113 or the portable Internet modem 123 such that the portable terminal can be operated in a mobile communication mode or a portable Internet mode, according to the type of received RF signal (for example, a mobile communication signal and/or a portable Internet signal) and/or the type of call.

When electric power is supplied to the portable terminal, the controller 190 drives the mobile communication modem 113 and portable Internet modem 123, respectively, to perform initialization of the mobile communication network and the portable Internet network. The controller 190 performs control such that the mobile communication modem 113 and the portable Internet mode 123 can be operated independently without affecting the other's settings. Therefore, even when there are originating/terminating calls in the mobile communication mode, the controller 190 allows the portable Internet modem 123 to perform call setting in the portable Internet network. Also, when the portable terminal performs call terminating, the controller 190 controls the mobile communication modem 113 and/or the portable Internet modem 123 to allow the portable terminal to be operated in the mobile communication network and/or portable internet network, to transmit paging messages to other portable terminals.

Alternatively, the controller 190 includes a modem controlling unit that sets the above-described condition to control the mobile communication modem 113 and the portable internet modem 123. The modem controlling unit may be included in the mobile communication modem 113 or the portable Internet modem 123, instead of being included in the controller 190.

Specially, the controller 190 measures electric current used by the mobile communication unit 110 and the portable Internet unit 120, based on Received Signal Strength Indicator (RSSI) level, and controls the power supply 180 according to the measured electric current, thereby selectively supplying electric power to the respective function blocks (i.e., the mobile communication unit 110 and the portable Internet unit 120).

Here, although the embodiment of the present invention of FIG. 1 is illustrated with the mobile communication RF module 111 and the portable Internet RF module 121 are individually configured, and the mobile communication modem 112, portable Internet modem 123, and controller 190 are also individually configured, it will be appreciated that such a configuration does not limit the present invention. For example, the mobile communication RF module 111 and the portable Internet RF module 121 may be implemented on a single RF module chip. The mobile communication modem 113, portable Internet modem 123, and controller 190 may be also implemented on a single chip.

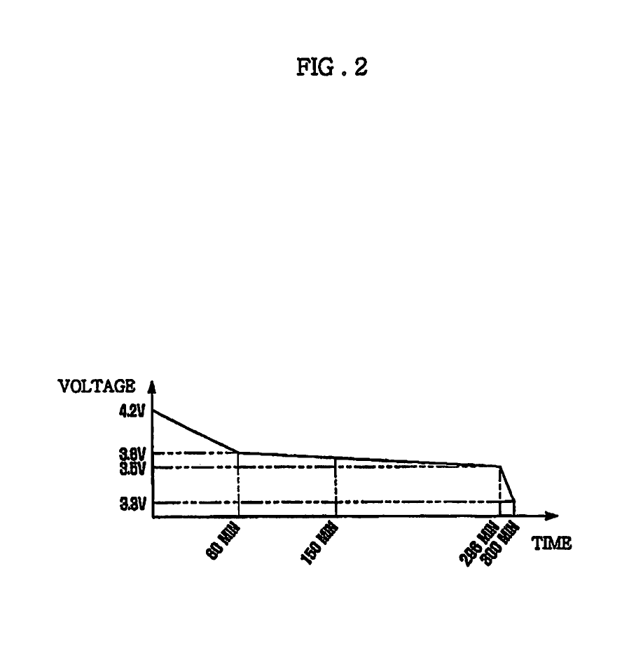

The following is a description of another embodiment of the present invention, in which battery characteristic information is previously stored and then used to calculate consumption current according to RSSI level and remaining run time of the portable terminal based on the calculated consumption current. The battery characteristic information refers to data created by using a characteristic graph of the battery, and is stored. Such a process is described with reference to FIG. 2.

FIG. 2 is a graph of battery to storage characteristic information according to an embodiment of the present invention. As shown in FIG. 2, the graph shows that a standard battery of 900 mA/h being discharged in a calling mode. Here the calling mode refers to a state where consumption current is 320 mA; the characteristic graph is obtained with the RSSI level is a middle electric field; the period of time slot employs the period of slot cycle 2 of which the interval is 5.12 seconds; and power sector (SECTOR_POWER) is in a state of −90 dB.

The present invention stores characteristic information of a battery, created from the characteristic graph of the portable terminal battery, in the storage unit 130. The battery characteristic information is used to calculate the remaining run time of a portable terminal in a mobile communication mode and a portable Internet mode. More specifically, the remaining run time is calculated so that consumption currents of respective function modes are derived according to previously stored RSSI levels, and then the derived consumption currents are compared with the characteristic information. For example, when the consumption current is 350mA in a mobile communication mode, it is compared with the characteristic graph to calculate the remaining run time. The present invention considers the RSSI level to calculate consumption current, because the consumption current varies according to the RSSI level. For example, when the RSSI level indicates a weak electric field, a portable terminal increases its output level, Tx Power Level, and thus consumes a relatively high amount of current. Therefore, the battery consumes its electric power more rapidly. The consumption current according to RSSI level can also be replaced with experimentally derived values.

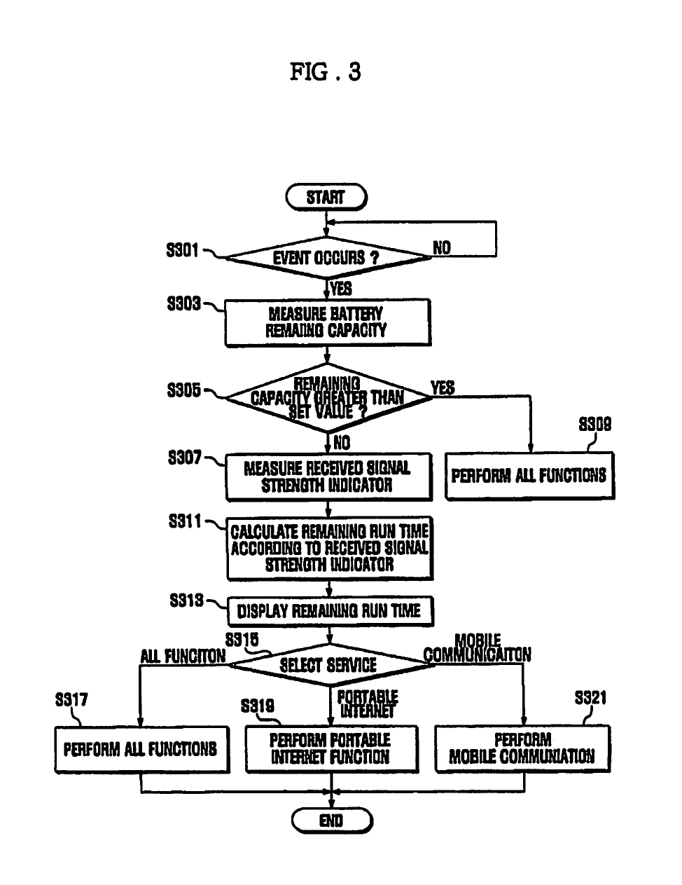

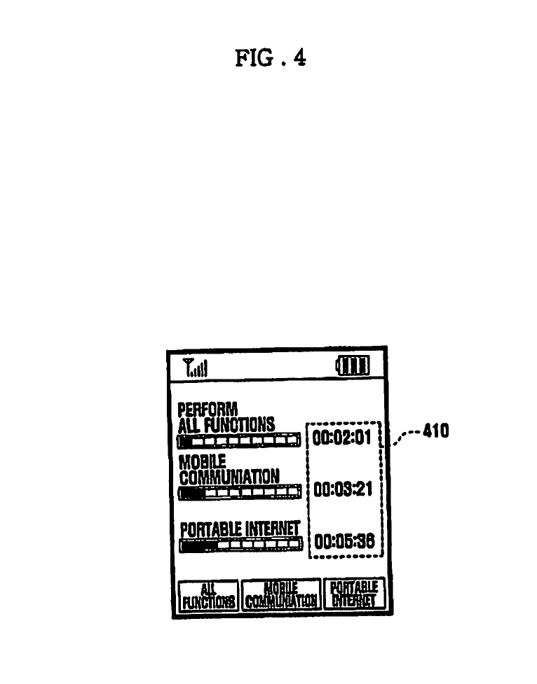

The following is a description of a method for controlling the electric-power of a battery when the portable terminal storing such characteristic information of a battery is simultaneously operated in a mobile communication mode and a portable Internet mode. FIG. 3 is a flow chart describing a method for controlling current consumption of a portable terminal according to an embodiment of the present invention. FIG. 4 shows a display corresponding to the method for controlling current consumption of a portable terminal according to an embodiment of the present invention.

As shown in FIG. 3, when an event occurs in Step 301, which a mobile communication service and a portable Internet service are simultaneously provided, the controller 190 detects occurrence of an event and measures the remaining capacity of the battery in Step 303. As a typical example, the event refers to a case where the portable terminal receives an incoming call through the mobile communication service while downloading movie data using the portable Internet service.

The battery measuring unit 170 measures the remaining battery capacity and transmits the measured capacity to the controller 190. Then, the controller 190 determines whether the remaining capacity is greater than a preset value in Step 305. Here, the preset value refers to a boundary value (or a critical value) of the battery capacity that corresponds to a battery capacity allowing the portable terminal to provide the mobile communication service and the portable Internet service, simultaneously. The value can be experimentally obtained and set to the portable terminal. Such a process allows the resources of the portable terminal to be managed efficiently, because the calculation of remaining runtimes of respective function modes (for example, a mobile communication mode and a portable Internet mode), as described later, is not needed, when the controller determined that the remaining battery capacity is sufficient according to the preset value.

When the determination of Step 305 is negative, or the remaining battery capacity is less than the preset value, the controller 190 measures the RSSI level in Step 307. On the other hand, when the determination of Step 305 is positive, i.e. the remaining battery capacity is greater than the preset value, the controller 190 allows the mobile communication service and the portable Internet service to be simultaneously provided, described above.

Next, the controller 190 calculates the remaining run times based on the RSSI level of the respective measured function modes in Step 311. Specifically, the controller 190 derives the remaining run times when the respective function modes are performed, and the remaining run time when the respective function modes are simultaneously performed.

More specifically, consumption currents of the respective function modes are derived according to the RSSI level. After that, the remaining run times of the portable terminal are calculated according to the derived consumption currents and the characteristic information of the battery previously stored. The consumption currents can be obtained that the experimental values corresponding to RSSI levels are previously stored; and of them, an experiment value is searched, so that it can correspond to the RSSI level measured by the mobile communication unit 110 and the portable Internet unit 120. The output level of the portable terminal is varied according to the RSSI level. That is, a higher RSSI level indicates a strong electric field and electric power consumption current is reduced. The remaining run time of the portable terminal can be obtained by comparing the consumption current with characteristic information of the battery that includes values of a characteristic graph of the battery. That is, the greater the consumption current the more the remaining run time is reduced.

Next, the controller 190 displays the calculated remaining run time through the display in Step 313. Such a display displaying the remaining run time is illustrated in FIG. 4. As shown in FIG. 4, respective remaining run times are displayed of the mobile communication service and the portable Internet service and the remaining run time when the two services are simultaneously provided. Therefore, referring to the remaining run times 410 on the display, a user can use the portable terminal so that it can perform one of the functions or both functions by selecting a corresponding key. When one of the keys to provide corresponding services is selected, the controller 190 detects the key input and proceeds to the next step corresponding to the detected key input in Step 315.

When the key input is to perform all functions, the controller 190 controls the portable terminal to provide both the mobile communication service and the portable Internet service in Step 317. When the key input is to perform the portable Internet function, the controller 190 controls the portable terminal to provide the portable Internet service in Step 319. Also, when the key input is to perform the mobile communication function, the controller 190 controls the portable terminal to provide the mobile communication service in Step 321.

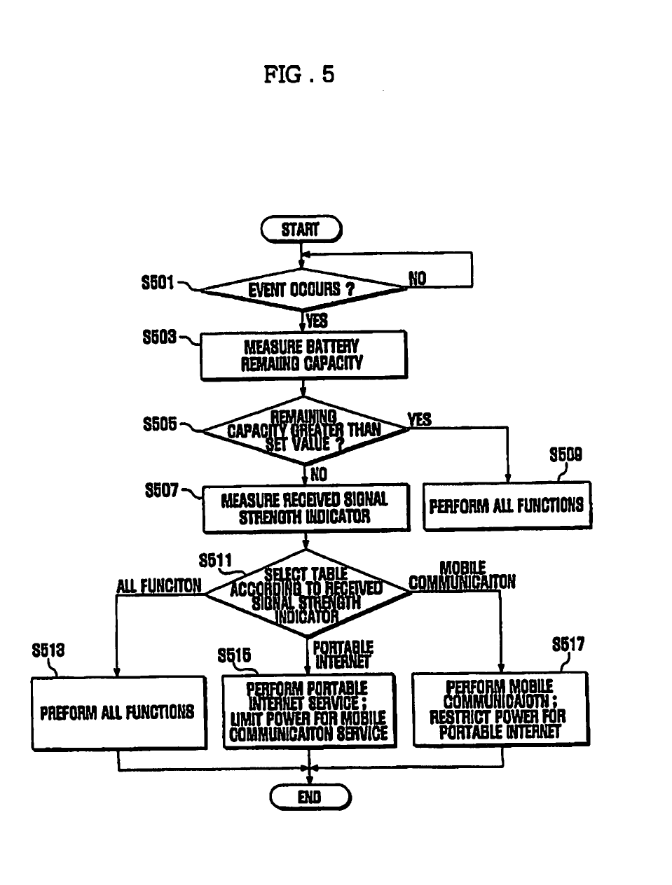

A description is now provided of a method where power of a portable terminal battery is automatically controlled to restrict the services provided, determined by a user's setting. FIG. 5 is a flow chart describing a method for controlling electric power of a battery of a portable terminal according to a preferred embodiment of the present invention, making reference to the parts described in FIG. 3.

As shown in FIG. 5, when an event occurs in Step 501, where a mobile communication service and a portable Internet service are simultaneously provided, the controller 190 detects occurrence of the event and measures the remaining capacity of the battery in Step 503. After that, the controller 190 determines whether the remaining capacity is greater than a preset value in Step 505.

When the determination of Step 505 is negative or the remaining battery capacity is less than the preset value, the controller 190 measures the RSSI level in Step 507. On the other hand, when the determination of Step 505 is positive, or the remaining battery capacity is greater than the preset value, the controller 190 allows the mobile communication service and the portable Internet service to be simultaneously provided in Step 509.

After measuring the RSSI level, the controller 190 searches for a processing method table including processes according to RSSI level, based on the RSSI level measured in Step 509, in Step 511. Such a processing method table may be preset by a user.

Based on the search result, the controller 190 proceeds to Step 513 in which all functions are performed, to Step 515 in which a mobile communication function providing a mobile communication service is performed, or to Step 517 in which a portable Internet function providing a portable Internet service is performed. Here, the process of the processing method, described by the Steps 513 to 517, are classified and set based on respective functions according to RSSI level for mobile communication and portable Internet services, by using consumption currents based on RSSI levels previously stored.

The following Table 1 describes a processing method according to an embodiment of the present invention.

TABLE 1

| | RSSI | | |
|---|---|---|---|
| | for mobile | RSSI for portable | |
| | communication | Internet | Processes |
| 1 | Strong | Strong | Enable All Functions |
| 2 | Strong | Middle | Enable All Functions |
| 3 | Strong | Weak | Disable Portable Internet |
| 4 | Middle | Strong | Use All Functions |
| 5 | Middle | Middle | Use All Functions |
| 6 | Middle | Weak | Disable Portable Internet |
| 7 | Weak | Strong | Disable Mobile Communication |
| 8 | Weak | Middle | Disable Mobile Communication |
| 9 | Weak | Weak | Use Mobile Communication |

Table 1 describes respective processes of the processing method, associating with RSSI levels for mobile communication and portable Internet, in which the processes are previously set. Since consumption current can be previously estimated according to the RSSI level, the remaining run time of the portable terminal can be also calculated. Also, when the portable terminal is used in a weak electric field, its consumption current increases such that the remaining run time of the portable terminal is shortened. Therefore, the portable terminal in the weak electric field restricts its services so that all the services cannot be provided, while some are provided. Thus, the remaining run time of the portable terminal to continue to provide current services can be extended. Accordingly, the present invention can perform the respective processes according to RSSI levels based on the previously stored information of Table 1. However, it will be appreciated that the present invention is not limited by the processing method of Table 1. For example, the portable terminal can be set to perform all functions, even when the RSSI of the mobile communication is a middle electric field and the RSSI of the portable Internet is a weak electric field, as described in row 6 of Table 1.

While the present invention has been particularly shown and described with reference to embodiments thereof, it will be understood by those of ordinary skill in the art that various changes in form and details may be made therein without departing from the spirit and scope of the present invention as defined by the following claims. For example, when the battery remaining capacity is less than the set value, one of functions the portable terminal provides is restricted, thereby extending the remaining run time of the portable terminal. Also, a user can set a portable terminal such that the portable terminal can operate, as the user desires, as one of the functions of the portable terminal is restricted. Therefore, the portable terminal can be efficiently used.

What is claimed is:

1. An apparatus for electric power management according to Received Signal Strength Indicator (RSSI) of a Dual Band Dual Mode (DBDM) terminal that provides a mobile communication service and a portable Internet service, the apparatus comprising:
a mobile communication unit for transmitting/receiving a mobile communication signal;
a portable Internet unit for transmitting/receiving a portable Internet signal;
a battery measuring unit for measuring remaining battery capacity;
a power supply unit for supplying battery power to the mobile communication unit and portable Internet unit; and
a controller for deriving remaining run times of the mobile communication unit and portable internet unit using consumption current according to the RSSI of the mobile communication unit and the portable Internet unit when the remaining battery capacity of the battery measuring unit is less than a set value, and for controlling power supply of the power supply unit based on the derived remaining run times.

2. The apparatus of claim 1, further comprising a display for displaying the remaining run times derived by the controller.

3. The apparatus of claim 1, further comprising a storage unit for storing characteristic information created from battery specifications and information created from consumption current according to RSSI.

4. The apparatus of claim 1, further comprising an antenna for transmitting/receiving the mobile communication signal and the portable Internet signal to/from a base station.

5. A method of electric power management according to Received Signal Strength Indicator (RSSI) of a Dual Band Dual Mode (DBDM) terminal that provides a mobile communication service and a portable Internet service, comprising:
detecting occurrence of an event performing the mobile communication service and portable Internet service, simultaneously;
measuring battery consumption current when the event occurred, and determining whether the consumption current is less than the a preset critical value;
calculating remaining run times when respective services are individually provided, and remaining run time when services are simultaneously provided, based on the RSSI of the respective services, when the consumption current is less than the critical value; and
restricting power supply according to the remaining run times, and providing at least one of the services.

6. The method of claim 5, wherein the restricting power supply according to the remaining run times, and providing at least one or more of the services, comprises:
displaying the remaining run times;
detecting input signals corresponding to remaining run times; and
restricting power supply according to a detected input signal, and providing at least one of the services.

7. The method of claim 5, wherein the provided service has remaining run time longer than that of another service, wherein the provided service and other service are the mobile communication service and the portable Internet service.

8. The method of claim 5, wherein the restricting power supply according to the remaining run times, and providing at least one or more of the services, comprises:
providing all services when the battery is newly received by the portable terminal.

9. The method of claim 5, wherein the calculation comprises:
measuring consumption currents for the respective services according to the RSSI;
comparing the consumption currents with battery characteristic information previously stored; and
based on the comparison, calculating remaining run times when the respective services are individually provided, and remaining run time when the services are simultaneously provided.

10. The method of claim 9, wherein the battery characteristic information comprises a specification of the battery.

11. The method of claim 5, further comprising:
providing all the services, when the consumption current is greater than the preset critical value.
